(19) United States
(12) Patent Application Publication
(10) Pub. No.: US 2010/0316235 A1
(43) Pub. Date: Dec. 16, 2010

(54) BONE CONDUCTION SPEAKER WITH VIBRATION PREVENTION FUNCTION

(76) Inventors: Eui Bong Park, Bucheon-si (KR); Jong Wan Kim, Bucheon-si (KR)

Correspondence Address: BIRCH STEWART KOLASCH & BIRCH, PO BOX 747, FALLS CHURCH, VA, 22040-0747, US

(21) Appl. No.: 12/483,985

(22) Filed: Jun. 12, 2009

(51) Int. Cl. H04R 1/00

(52) U.S. Cl. 381/151

(57) ABSTRACT

A bone conduction speaker having a vibration prevention structure is disclosed. In the speaker structure that a magnet and a voice coil are installed in the interior of a housing disposed in an inner side of an external casing of a bone conduction speaker and are engaged with a yoke, and a diaphragm is installed in an outer side of the yoke, there is provided a bone conduction speaker having a vibration prevention structure which comprises one or at least two ribs which are formed as an outer side of the diaphragm is outwardly extended; and an engaging part which is disposed in an end of each rib and is fixedly assembled to the casing.

### TECHNICAL FIELD

The present invention relates to a bone conduction speaker, and in particular to a bone conduction speaker with a vibration prevention function which can achieve a clear sound quality in wider sound bands with the helps of a reliable conduction and recognition of a sound vibration bone-conducted through a skin contact of a human by maximizing a vibration sound efficiency in such a manner that a vibration sound is forwardly outputted from a bone conduction speaker using a structure configured to limit a spreading of a vibration sound of a bone conduction in an engaging potion of a body casing where a bone conduction speaker is engaged.

### BACKGROUND ART

A method that a person hears a certain sound may be classified into an air conduction method and a bone conduction method.

The air conduction method means that a sound is transferred from a tympanic membrane to an inner ear. The vibration of a sound transferred through air is first transferred to a tympanic membrane, and the vibration is finally transferred to a cochlea through three pieces of bone residing in an inner side of a tympanic membrane.

The cochlea is filled with a liquid called a Linba liquid, and the vibration of the liquid is converted into an electric signal and is transferred to an auditory nerve, so a brain of a human can recognize the sound.

The bone conduction method means that a sound from a cranial bone is transferred to a cochlea and then is transferred to a brain through an auditory nerve. In a noise recognition mechanism, the process that vibrations pass through a tympanic membrane and three pieces of bone residing in an inner side of a tympanic membrane is omitted.

Namely, as a sound vibration applied to a skin surface surrounding an ear is directly transferred to a cochlea through a cranial bone, even a person who has a hearing difficulty due to a problem in a tympanic membrane or an otosteon can hear with the helps of a bone conduction through a skin if the person has a normal cochlea and auditory nerve.

The basic construction of a conventional bone conduction speaker based on the above bone conduction principle will be described as follows.

As shown in FIG. 1, as a current is applied from an external power source to an electrode terminal plate 1, when a current is supplied to a voice coil 2 from an electrode terminal plate 1 through a coil, the voice coil 2 induces a change in a magnetic field from a sound signal electric energy. Namely, when a current is applied to the voice coil 2, an electric magnetic field occurs in the voice coils 2 disposed in a gap G of an electric magnetic circuit which is formed of an upper plate 3, a magnet 4 and a yoke 5, which is conducted based on Fleming's left hand rule.

In a state that the voice coil 2 is fixed, the upper plate 3, the magnet 4 and the yoke 5, which are integrally engaged, vibrate upward and downward with the helps of attractive force and repulsive force formed between the voice coil 2, the upper plate 4, and the yoke 5.

At this time, an upward and downward vibration is controlled uniform by limiting a free and random vibration of the electric magnetic circuit by using a damper 6 installed on an upper side of the yoke 5. The vibrations are transferred to a skin surface of a person contacting with a mastoid 8 disposed on an upper most portion of a fixing rivet 7. As a result, a certain vibration is obtained, which can be audible through a bone conduction sound vibration.

The voice coil 2 is fixed in a base plate 9, and an electric magnetic circuit, which may vibrate upward and downward, is formed of the yoke 5, the magnet 4 and the upper plate 3. The mastoid 8 is disposed on an upper most portion of the fixing rivet 7 for transferring a sound vibration to the outside, by means of which the head bones belonging to the cranial bone of a human can be directly vibrated, so an auditory nerve is stimulated through a bone conduction, whereby a normal person as well as a person who suffers a hearing difficulty can hear sounds.

The conventional bone conduction speaker designed based on a bone conduction principle has been mainly developed for an ordinary person who suffers from a hearing difficulty and an auditory-disabled person, so it is basically directed to hearing a low level sound vibration. In recent years, a lot of normal persons in addition to an auditory-disabled person use a bone conduction speaker applied to an earphone and a headphone for listening to a music using a mobile phone or a MP3 player, so various kinds of bone conduction speaker products are developed and currently used for listening to a voice and a music along with a reliable sound vibration.

As a prior art related to the present invention, the Korean patent registration number 10-390003 discloses a bone conduction speaker using a diaphragm, and a mobile phone equipped with the same, and the Korean patent publication number 10-2006-58078 discloses a functional speaker for a mobile terminal.

In the above prior arts, according to the bone conduction speaker using a diaphragm, and a mobile phone equipped with the same, it is directed to a bone conduction speaker having a vibration hearing function and a sound hearing function, in which a sound hearing and a vibration hearing can be selectively performed.

According to the functional speaker for a mobile terminal, an electric magnetic circuit is configured so that higher level vibration power can be obtained for music listening, which circuit is formed of a plurality of magnets and a vibration and a voice coil. An electric magnetic circuit for a speaker is added on an electric magnetic circuit for vibrations for thereby forming the electric magnetic circuit in one structure.

In the above conventional bone conduction speakers, the magnet, the diaphragm and the mastoid are integrally assembled for generating sound vibrations, and in particular the mastoid is formed in a plate shape.

When the diaphragm vibrates by means of the electric magnetic circuit as sound signals are inputted, the vibrations are transferred to the front side of the plate-shaped mastoid for thereby outputting sound vibrations.

However, the sound vibrations are transferred to the mastoid and at the same time are transferred to the whole portions of the body casing, which surrounds the bone conduction speaker, because there are problems in a structure configured to assemble a bone conduction speaker in the interior of the body casing.

Almost the conventional bone conduction speakers are applied to as a speaker for a mobile phone, so an auditory-disabled person as well as a normal person generally use the same in an industrial site having a lot of noises.

Since almost the engaging structures of bone conduction speakers are accommodated in the interiors of the upper and lower casings, so the whole surfaces of the bone conduction speaker are directly contacted with the casings.

In a method for assembling and fixing the bone conduction speaker, the mastoid is inserted into an accommodation part provided in the interior of the casing and is exposed to the outside of the casing through a through hole formed in a front side of the accommodation part, while contacting with the bone conduction portions of a human for thereby hearing sound vibrations.

In another method, the bone conduction speakers are simply fixed in the interior of the casing with a bracket and an engaging screw.

So almost the products equipped with a conventional bone conduction speaker have the following problems when hearing vibration sounds in their natural functions as a bone conduction speaker.

First, since the whole outer surfaces of the bone conduction speaker are assembled while being closely contacted with the interior of the casing, so the vibration sounds from the bone conduction speaker can be transferred to the mastoid as vibration sounds, but at the same time the vibration sounds spread through the whole portions of the body casing.

The vibration sounds should be transferred only to the mastoid in maximum, but since the bone conduction speaker closely contacts with the casing, the vibration sounds spread to the whole portions of the body casing, so the output efficiency of the vibration sounds significantly decrease.

Vibration sounds may not be reliably heard due to the spreading problems of the vibration sounds, and sometime they may be heard along with noises.

The elements used in the bone conduction speaker should be made of high quality parts in order to increase the levels of the vibration sounds as much as lost sounds, which leads to making the elements as well as the bone conduction speaker larger and larger. So the mobile phone, which may use the above elements, should be inefficiently made larger.

The above problems make the bone conduction speaker worse for its application to a mobile instrument design of a mobile phone which becomes smaller and smaller along with its slimming structure. The products related to the bone conduction speakers might be badly influenced.

In the assembling structure which uses an engaging screw for fixing a conventional bone conduction speaker, since the vibration sounds generated in the bone conduction speaker are directly transferred in the forward directions of the casing through the engaging screw and the engaging boss, the vibration sounds, which are originally designed to be transferred to only the mastoid of the bone conduction speaker, are spread toward the casings around the bone conduction speaker.

At this time, the sounds spread into the air by means of the sound vibrations cannot be heard by an auditory-disabled person, but can be heard by a normal person as weird sounds which are not lower level music sounds outputted from the normal sound speakers. So a user and surrounding persons may feel inconvenience and weird.

Since part of the vibration sounds from the surfaces of the casings around the mastoid spread through the surrounding air, a communication content might be transferred and heard by a normal standard person in the course of communication using a mobile phone, so it is impossible to obtain a reliable communication security in the conventional art.

### DISCLOSURE OF THE INVENTION

Accordingly, it is an object of the present invention to provide a bone conduction speaker with a vibration prevention function which overcomes the problems encountered in the conventional art.

It is another object of the present invention to provide a bone conduction speaker with a vibration prevention function which can achieve a clear sound quality in wider sound bands with the helps of a reliable conduction and recognition of a sound vibration bone-conducted through a skin contact of a human by maximizing a vibration sound efficiency in such a manner that an vibration sound is forwardly outputted from a bone conduction speaker by assembling a bone conduction speaker in the interior of a casing without having contacted with the inner sides of the casing and by using an anti-vibration structure configured to limit a spreading of a vibration sound of a bone conduction in an engaging potion of a body casing where a bone conduction speaker is engaged in the interior of a body casing.

It is further another object of the present invention to provide a bone conduction speaker with an anti-vibration structure in which a mastoid portion of a bone conduction speaker is closely contacted with a human skin, so a spreading of a vibration is effectively limited while a backside of a bone conduction speaker housing is being not contacted with a casing even when a bone conduction speaker is backwardly pushed when hearing a vibration sound with a mastoid portion of a bone conduction speaker is closely contacted with a human skin for thereby obtaining a vibration prevention function, and when a mastoid portion does not contact with a human skin, its original position is recovered for thereby preventing a sound vibration from being transferred to a casing with the helps of a shock absorbing member, by means of which it is possible to obtain a communication security since a sound occurring from a sound vibration is not spread to the outside through a casing as compared to the conventional art while preventing an uneasy noise such as noises caused due to a sound vibration from spreading.

To achieve the above objects, in a speaker structure that a magnet and a voice coil are installed in the interior of a housing disposed in an inner side of an external casing of a bone conduction speaker and are engaged with a yoke, and a diaphragm is installed in an outer side of the yoke, there is provided a bone conduction speaker having a vibration prevention structure which comprises one or at least two ribs which are formed as an outer side of the diaphragm is outwardly extended; and an engaging part which is disposed in an end of each rib and is fixedly assembled to the casing.

To achieve the above objects, in a speaker structure that a magnet and a voice coil are installed in the interior of a housing disposed in an inner side of an external casing of a bone conduction speaker and are engaged with a yoke, and a diaphragm is installed in an outer side of the yoke, there is provided a bone conduction speaker having a vibration prevention structure which comprises one or at least two ribs which are formed in an outer side of the housing; and an engaging part which is disposed in an end of each rib and is fixedly assembled to the casing.

In the ribs for a vibration prevention of a bone conduction speaker, an engaging part, which has an engaging hole for an engagement to the casing by means of an engaging member such as a screw or a rivet, is formed in an end of each rib, and a narrow neck is formed between the engaging part, the diaphragm and an outer side of the housing.

According to another example of the ribs, the rib is formed of a wrinkle part in a vertical or horizontal direction, and according to further another example of the ribs, the rib is bent in a Z-shape.

When assembling the engaging part of the ribs to the casing, an anti-vibration member is assembled to the upper and lower surfaces of the rib for thereby enhancing an impact and vibration prevention effect.

To achieve the above objects of the present invention, in a speaker structure that a magnet and a voice coil are installed in the interior of a housing disposed in an inner side of an external casing of a bone conduction speaker and are engaged with a yoke, and a diaphragm is installed in an outer side of the yoke, there is provided a bone conduction speaker having a vibration prevention structure which comprises one or at least two ribs which are formed as an outer side of the diaphragm is outwardly extended; an engaging part which is disposed in an end of each rib and is fixedly assembled to the casing; and an elastic member which is disposed closer to a backside of the housing for thereby providing an elastic force with respect to a vertical vibration direction of the housing.

According to an elastic force provision member which is added to another vibration prevention structure of the present invention, in a speaker structure that a magnet and a voice coil are installed in the interior of a housing disposed in an inner side of an external casing of a bone conduction speaker and are engaged with a yoke, and a diaphragm is installed in an outer side of the yoke, there is provided a bone conduction speaker having a vibration prevention structure which comprises one or at least two ribs which are formed in an outer side of the housing; an engaging part which is disposed in an end of each rib and is fixedly assembled to the casing; and an elastic member which is disposed closer to a backside of the housing for thereby providing an elastic force with respect to a vertical vibration direction of the housing.

The elastic member is formed of a sponge, and the elastic member is formed of a spring, and the spring is formed in a double structure that it is installed closer to a backside of the housing and it is directly connected with an outer surface of the housing.

According to another embodiment of the present invention, the spring is directly installed in contact with a backside of the housing, and a power supplied to the housing is electrically connected by means of the assistant spring.

### Effects

The bone conduction speaker according to the present invention is equipped with an anti-vibration structure and a soundproof structure which can be applied to a mobile instrument such as a mobile phone or the like for thereby maximizing an output of a sound vibration of a bone conduction, which is forwardly outputted, by limiting a spreading of a sound vibration toward a body casing when the sound vibration is outputted from a diaphragm.

In the present invention, it is possible to make a small size speaker for a mobile instrument such as a mobile phone having a compact sized and thin structure without having adapted a high level output bone conduction speaker, so a wider sound band and clear quality sound can be heard for long time with the helps of a bone conduction speaker of the present invention even in a noisy area like an industrial site.

The vibration sounds are not spread to the outside since noises due to a sound vibration do not occur with the helps of a shock-absorbing structure disposed in a backside of a bone conduction speaker, by means of which a communication security in a mobile phone can be obtained, and noises due to a sound vibration do not occur when hearing a high level output music.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic cross sectional view for describing the construction of a conventional bone conduction speaker;

FIG. 2 is an assembled cross sectional view illustrating a vibration prevention construction of a bone conduction speaker according to an embodiment of the present invention;

FIG. 3 is an assembled cross sectional view illustrating a vibration prevention construction of a bone conduction speaker according to another embodiment of the present invention;

FIG. 4 is a plane view illustrating a vibration prevention structure applied to a diaphragm of a bone conduction speaker according to the present invention;

FIG. 5 is an assembled cross sectional view illustrating another example of a vibration prevention structure applied to a diaphragm according to the present invention;

FIGS. 6 and 7 are assembled cross sectional views illustrating a noise prevention shock-absorbing structure applied along with a vibration prevention structure and a power supply state of a bone conduction speaker according to the present invention; and

FIGS. 8 and 9 are assembled cross sectional views for describing an operation and effect of a bone conduction speaker according to the present invention.

### MODES FOR CARRYING OUT THE INVENTION

The preferred embodiments of the present invention will be described with reference to the accompanying drawings.

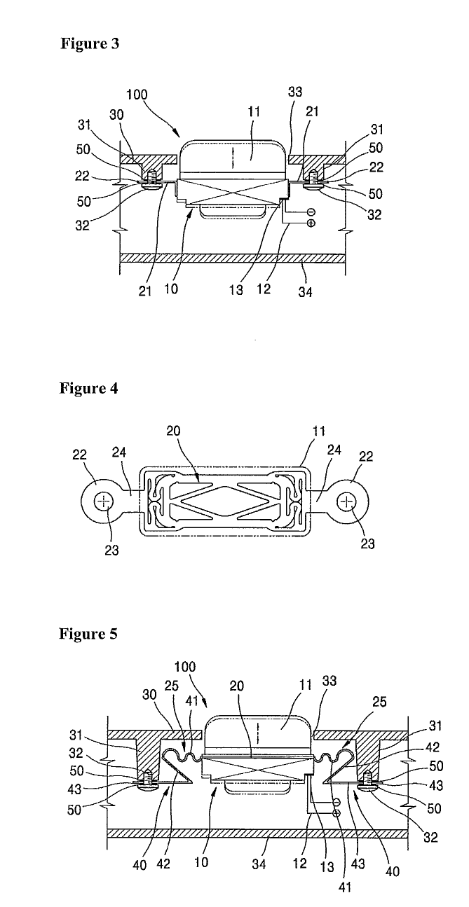

FIG. 2 is an assembled cross sectional view illustrating a vibration prevention construction of a bone conduction speaker according to an embodiment of the present invention. FIG. 3 is an assembled cross sectional view illustrating a vibration prevention construction of a bone conduction speaker according to another embodiment of the present invention. FIG. 4 is a plane view illustrating a vibration prevention structure applied to a diaphragm of a bone conduction speaker according to the present invention. FIG. 5 is an assembled cross sectional view illustrating another example of a vibration prevention structure applied to a diaphragm according to the present invention;

As shown therein, the bone conduction speaker 100 according to the present invention is configured as having similar elements with the conventional bone conduction speaker.

So the known necessary elements needed for the descriptions of the inner construction of the bone conduction speaker may be directly used in the present invention as well, and only the necessary elements may be given numeral references.

The bone conduction speaker 100 is equipped with a voice coil installed with the helps of a coil plate fixedly installed in the interior of a housing 10. Magnets are disposed in the inner and outer sides of the voice coil and are engaged with a yoke. A diaphragm 20 contacts with an outer surface of the yoke with its edge being supported by means of the housing 10 and is integrally equipped with a mastoid 11 in its front side. A power supply line 12 is circuit-connected with a lower end of the housing 10.

The vibration prevention structure according to the present invention having the above construction will be described as being applied to a mobile phone. The body casing 30 of a mobile phone is generally designed in a slim thin structure. In particular, the portion where the bone conduction speaker 100 is engaged is very slim and relatively thinner.

It is preferred that the bone conduction speaker applied to the slim body casing 30 is configured with a thinner thickness and narrower width, not in a circular shape for an efficiency use of space. A bone conduction speaker according to the present invention is preferably configured in a rectangular parallelepiped shape in which a voice coil, a yoke, a diaphragm and a mastoid 11 are all configured in a rectangular parallelepiped shape.

In the vibration prevention structure applied to a bone conduction speaker, the bone conduction speaker 100 is accommodated in the interior of the casing 30, with its outer surface not contacting with an inner surface of the casing 30, namely, being suspended in its interior like a hanger.

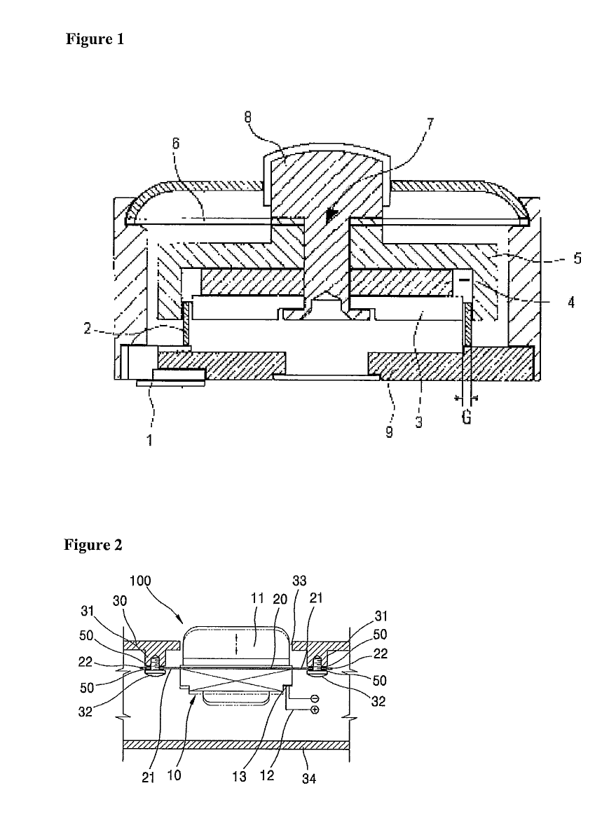

As an embodiment of the present invention, as shown in FIG. 1 the bone conduction speaker is assembled in a hanger shape using the diaphragm 20.

The diaphragm 20 is made of a metallic material having a certain elastic force and is formed in a rectangular shape, with an outer surface of the diaphragm 20 being extended toward the outside for thereby forming at least two ribs 21.

The ribs 21 are extended from the outer sides of the housing, with a circular engaging part 22 with an engaging hole being formed in each rib 21, so it can be assembled to a boss 31 using an engaging screw 32. The boss 31 is protruded from an inner side of the casing 30.

The bone conduction speaker 100 is assembled while being suspended in the interior of the casing 30 with the helps of the diaphragm 20 and the boss 31, and the mastoid 11 is slightly protruded to the outside through a slot 33 formed in a front side of the casing 30.

According to another embodiment of the present invention, as shown in FIG. 2, one or at least two ribs 20 may be extended from an outer surface of the housing 10 without extending the ribs 21 from the diaphragm 20.

The ribs 20 may be integrally extended from an outer surface of the housing 10. No not shown in the drawings in details, a rib 20 prefabricated as a part may be attached to an outer surface of the housing 10 or may be slide-inserted.

A circular engaging part 22 with an engaging hole 23 is disposed in an end of each rib 21 and is assembled to the boss 31 protruded in the inner side of the casing 30 using an engaging screw 32.

The bone conduction speaker according to the present invention assembled in the interior of the casing body casing 30 in a hanger type is configured so that the vibration sounds occurred in the interior are transferred to the mastoid 11 through the diaphragm 20 and at the same time are transferred toward the engaging part 22 through the ribs 21 formed in the outer surface of the diaphragm 20 or the housing 10, respectively.

In the present invention, since the vibration sounds are spread only toward the engaging part 22 through the ribs 21, not spread and transferred to the whole portions of the casing 30 as compared to the conventional art in which the housing and the casing directly contact with each other, an output efficiency of the vibration sounds transferred to the mastoid 11 is very high. So it is possible to obtain a high level vibration voice or vibration sound enough to communicate with a mobile phone even when a low level output bone conduction speaker 100 is actually applied.

In the preferred embodiment of the present invention, when being extended from the diaphragm 20, the ribs 21 can be extended with the same width as the width of the diaphragm 20, but in another embodiment of the present invention, as shown in FIG. 4, a neck part 24 having a narrower width may be formed between the outer side ends of the engaging part 22 and the diaphragm 20 with respect to the width of the diaphragm 20.

With the construction of the ribs 21, the transfer of the vibration sounds may be delayed in the section of the neck part 24 whose width is sharply decreased and offset when the vibrations are transferred toward the ribs 21 as much as the levels corresponding to the entire widths of the vibration diaphragm 20, so almost vibration sounds are concentrated on the side of the mastoid 11 for thereby generating higher level vibration sounds.

The vibration sounds generated from the bone conduction speaker 100 by means of an operation of the neck part 24 having a narrow width of the rib 21 become clear through the mastoid 11, and the vibration sounds transferred to the engaging part 22 through the ribs 21 are offset, so that no vibrations occur through the casing 30 for thereby minimizing the noises as compared to a conventional assembling construction.

The construction that the neck part 24 of the narrower width of the rib 21 was applied to the diaphragm 20 was described so far. Even when it is applied to the ribs 21 adapted to the housing 10, it is obvious that the same effects can be obtained.

According to farther another embodiment of the present invention, a wrinkle part 25 formed in a vertical or horizontal direction is provided, and according to still further another embodiment of the present invention, the ribs 40 may be bent in a shape of Z.

The wrinkle part 25 is continuously formed in a vertical direction of upward and downward sides or in a horizontal direction of leftward and rightward sides from an outer surface of the diaphragm 20 or the housing 10, which defines a bent structure in a circular shape, a triangle shape or a rectangular shape. It is obvious that a wrinkle part formed in a certain shape can belong to the claim scope of the present invention.

As shown in FIG. 5, the ribs 40 bent in a shape of Z is formed of an upper part 41, an inclined part 42 and an engaging part 43.

The upper part 41 may be formed in a straight shape or as shown in FIG. 5, it may be formed of a wrinkle part 25.

A wrinkle part 25 may be formed in an upper side of the rib 40 as a circular part of the same is continuously bent upward and downward in a vertical direction, and it may be bent in a shape of Z as the inclined part 42 and the engaging part 43 are formed.

According to the construction of the ribs 40, the vibration sounds generated from the diaphragm 20 are transferred to the mastoid 11 and at the same time are transferred to the ribs 40, so the entire transfer paths are extended with the helps of the wrinkle part 15 as compared to a straight transfer construction.

The transfer force of the vibration sounds transferred to the engaging part 43 through the inclined part 42 is gradually decreased, so almost vibration sounds outputted from the diaphragm 20 are concentrated on the mastoid 10 with the helps of offsetting operations, whereby it is possible to output high level vibration sounds.

With the helps of the construction and operation of the wrinkle part 25 of the ribs 40 and the Z-shaped construction, the vibration sounds outputted from the bone conduction speaker 100 become clearer through the mastoid 11, and the vibration sounds transferred to the engaging part 43 through the ribs 40 are offset, so the noises occurring from the casing 30 due to vibrations can be significantly decreased and substantially prevented as compared to a conventional assembling construction.

The constructions of the wrinkle part 25 of the ribs 40 and the Z-shaped bent structure may be applied to the diaphragm 20 as well as the ribs 21 adapted to the housing 10.

In the above preferred embodiments of the present invention, in the constructions of the wrinkle part 25 of the ribs 40 and the Z-shaped bent structure, when the mastoid 11 is closely contacted, the entire bone conduction speaker 100 is pushed backward.

At this time, the speaker 100 is elastically shock-absorbed with the helps of the wrinkle part 25 of the ribs 40 and the Z-shaped bent structure. Even when the mastoid 11 is closely contacted with a human skin, the vibration sounds outputted from the diaphragm 20 can be transferred through the bone conduction path, so a user can comfortably hear vibration sounds.

According to still further another embodiment of the present invention, a certain anti-vibration structure may be additionally applied when assembling the engaging part 22 of the rib 231 is assembled to the boss 31 of the casing 30 using a screw 32.

Namely, a double anti-vibration structure can be obtained by forming an anti-vibration member 50 in a washer type in the engaging part 22 of the rib 21 and disposing the formed anti-vibration member between the boss 31 and the engaging part 22 and between the engaging part 22 and the engaging screw 32.

Here the anti-vibration member 50 may be formed of a non-woven fabric or a rubber and may be formed of a certain material which even has an anti-vibration function.

The vibration sounds outputted from the diaphragm 20 are gradually offset while passing through the ribs 21, and the residual vibrations are absorbed by means of the anti-vibration member 50, so no vibrations are transferred to the boss 31 of the casing 30.

The bone conduction speaker 100 equipped with the double anti-vibration structure may be applied to an expensive mobile product such as a mobile phone for a high quality sound, so an ordinary person and an auditory-disabled person can hear a clear and excellent vibration sound.

Since the vibration sounds are not transferred through the boss 31 of the casing 30, a communication content or other sounds are not spread through the casing 30, so surrounding persons cannot hear a communication content, which leads to a reliable communication security.

When the present invention is applied to a mobile communication instrument such as a mobile phone or the like, when a person hears a vibration sound by closely contacting the mastoid 11 of the bone conduction speaker 100 to a skin, the entire bone conduction speaker 100 may be backwardly pushed, so the backside of the housing 10 may contact with the rear casing 34.

The preferred embodiments of the present invention are basically directed to preventing a spreading of vibrations by preventing the backside of the housing 1 from contacting with the rear casing 34 when the bone conduction speaker 100 is backwardly pushed. When the mastoid 11 does not contact with the skin, the bone conduction speaker returns to its original position with the helps of a shock-absorbing member for thereby preventing the vibration sounds from being spread to the outside through the casing 30 as compared to the conventional art, so a reliable communication security can be obtained, and uneasy noises are prevented from spreading to the outside.

Since the bone conduction speaker having an anti-vibration function and a shock-absorbing construction for a noise prevention is basically formed of an anti-vibration structure, the repeating constructions and operations will be omitted. The names and numeral references used earlier are used.

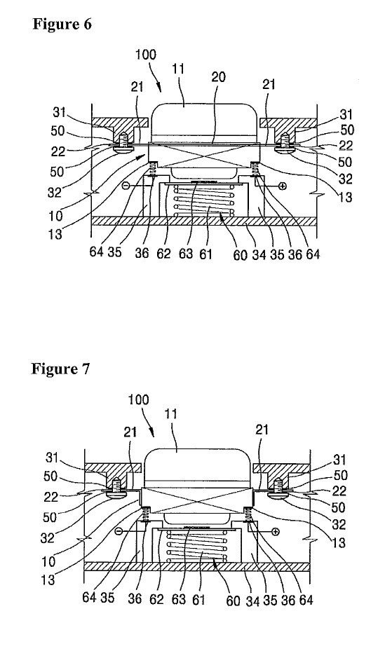

As shown in FIGS. 6 and 7, one or two ribs 21 are disposed on an outer surface of the diaphragm 20 or the housing 10, and the engaging part 22 is formed on an end of each rib 21 for an engagement of the boss 31 of the casing 30 using an engaging screw 32.

An elastic member 60 is installed closer to a backside of the housing 10 for providing an elastic force with respect to a vertical vibration direction of the housing 10 by means of the vibration sounds in an inner side of the rear casing 34.

The elastic member 60 is provided for preventing a contact of the rear casing 34 with a backside of the housing 10 when the housing 10 is backwardly pushed when the mastoid 11 contacts with a human skin for thereby absorbing the vibration sounds from the diaphragm 20, so the output of the vibration sounds toward the mastoid 11 can be maximized.

The elastic member 60 may be formed of a certain material such as sponge or the like.

The hardness of the sponge is determined as having a substantial shock-absorbing function when the housing 10 is backwardly pushed or the vibration sounds are transferred.

The elastic member 60 may be formed of a spring 61. The spring 61 is classified into a plate spring and a coil spring. In the present invention, a coil spring is preferably used.

The lower side of the spring 62 supports the inner side of the rear casing 34, and its upper side is equipped with a support plate 62 for a stable contact with a backside of the housing 10.

A cushion member 63 directly contacting with a backside of the housing 10 is attached on an upper surface of the support plate 62 and is preferably made of a sponge or non-woven fabric or a rubber material which is capable of shock-absorbing when the housing 10 is backwardly pushed.

The spring 61 forming the elastic member 60 according to the present invention may be disposed in a double shock-absorbing structure in such a manner that the spring 61 is installed closer to the backside of the housing 10 and it is directly connected with a surrounding surface of the housing 10.

An assistant spring 64 having a smaller elastic force is installed in a surrounding edge portion of the housing 10 in an outer side of the spring 61.

The assistant spring 64 may keep contacting with the housing 10 or may contact only when the housing is backwardly pushed.

In the construction that the assistant spring 64 keeps contacting with the housing 10, it may function like a terminal for applying a power and an audio signal to the voice coil(not shown) of the bone conduction speaker 100.

A connection terminal 14 is formed in a portion contacting with the assistant spring 64 in the housing 10, and a power terminal 36 is formed on an upper surface of the support member 35 disposed in the rear casing 34 for a contact with the assistant spring 64 for thereby forming an electric circuit.

With the above-described construction, even when the mastoid 11 contacts with a human skin and is backwardly pushed when hearing a vibration sound, its backward movement is absorbed by means of the spring 61 and the assistant spring 64 disposed in the rear center and surrounding portion of the housing 10, respectively, while preventing a contact between the housing 10 and the casing 30. When a person does not hear a vibration sound, the bone conduction speaker 100 returns to its original position by means of an elastic recovery force of the spring 61 and the assistant spring 64 as the mastoid 11 gets away from the skin.

When a person hears a vibration sound in a state that the housing 10 remains backwardly pushed, the vibration sounds transferred to the spring 61 and the assistant spring 64 contacting with the backside of the housing 10 are absorbed and offset, so the vibration sounds are not spread for thereby preventing noises.

The circuit connected with the bone conduction speaker 100 equipped with a vibration prevention structure may not be wire-connected, but a certain connection circuit may be formed by means of the assistant spring 64. So even when a vibration prevention function is added, a power supply can be stably and reliably achieved.

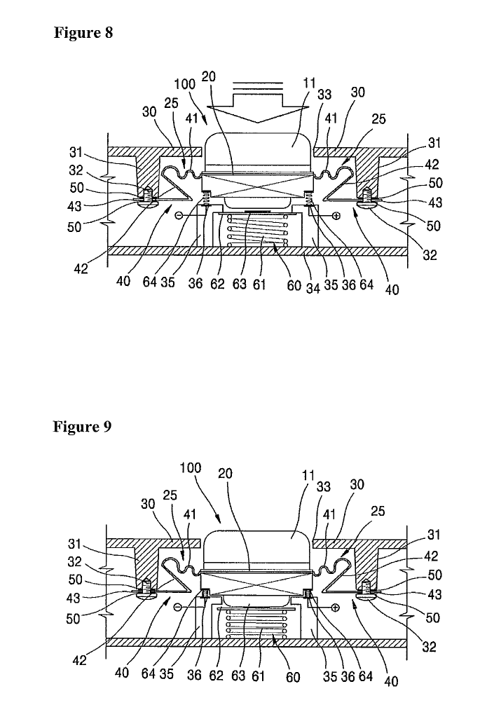

The operations of the bone conduction speaker having a vibration prevention structure according to the present invention will be described with reference to FIGS. 8 and 9.

FIGS. 8 and 9 are cross-sectional views illustrating the assembly equipped with a shock-absorbing and a power supply construction for a vibration prevention function and a noise prevention function in a vibration prevention structure of a bone conduction speaker according to the present invention. The operation when the present invention is applied to a mobile phone will be described.

When the bone conduction speaker 100 is applied to a mobile phone, voice and sound vibrations occur, and when a communication does not happen, it is used for listening to music.

Therefore, when a user makes the bone conduction speaker 100 contact closer to the ear for communication, the mastoid 11 gets in contact with a human skin, and at the same time the entire bone conduction speaker 100 is backwardly pushed in the interior of the casing 30.

In a shock-absorbed state by means of the elastic member 60 disposed in a backside of the housing 10, namely, the spring 61, a user hears vibration sounds, and a power and signal supply is obtained based on the construction of a connection circuit by means of the assistant spring 64 in the backside of the housing 10, so that vibration sounds can be outputted through the diaphragm 20 and the mastoid 11 based on a vibration sound generation principle in the interior of the bone conduction speaker 100.

Almost the vibration sounds outputted in the course of communication are transferred to the mastoid 11 through the diaphragm, so an ordinary and auditory-disabled person user can hear vibration sounds through the bone conduction path even when there are a lot of noises.

The vibration sounds are offset by means of an elastic operation of the ribs 21 or a construction of the wrinkle part 25 of the rib 40, the inclined part 42 and the engaging part 43. Since the vibration sounds are not transferred to the boss 31 of the casing 30 with the helps of the anti-vibration member 50 disposed in the engaging parts 22 and 43, almost the vibration sounds are outputted toward the mastoid 11, so the user can hear a high quality of vibration sounds.

Since the vibration sounds are not spread toward the boss 31 of the casing 30, a surrounding person does not hear a communication content along with a reliable communication security in the course of vibration sound communication.

When the mastoid 11 is in contact with a human skin, the bone conduction speaker 100 returns to its original position by means of the ribs 40 and an elastic recovery force of the spring 61 and the assistant spring 64 elastically supported by means of the backside of the housing 10, so the casing 30 remains non-contacted, namely, is suspended in the interior.

When the vibration sounds are outputted in a non-contact state, the vibration sounds are concentrated on the mastoid 11 in a state that the mastoid 11 is not closely contacted with the skin and are not outputted at a high level, so the vibration sounds are directly outputted through the mastoid 11, which may output noises.

However, in the present invention, when the mastoid is in contact with the skin, the housing 11 is freely suspended by means of the ribs 21 and 40, so it is not biased in the interior of the casing 30 without distortion in left and right directions while generating vibration sounding and at the same time reciprocating an upward and downward movement.

In this state, since the vibration sounds outputted from the diaphragm 20 are slightly spread into air through the mastoid 11, a user can feel a small amount of vibration sounds. As a result, vibration sounds are not outputted in a form of sound.

When the mastoid changes to a non-contact state in the course of communication using a mobile phone, an auditory-disabled person, a person having a difficulty in hearing and a normal person may recognize that vibration sounds are disconnected, so the vibration sounds are not outputted in noise forms while not being transferred to the outside.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a speaker structure that a magnet and a voice coil are installed in the interior of a housing disposed in an inner side of an external casing of a bone conduction speaker and are engaged with a yoke, and a diaphragm is installed in an outer side of the yoke, a bone conduction speaker having a vibration prevention structure, comprising:
one or at least two ribs 21 which are formed as an outer side of the diaphragm 20 is outwardly extended; and
an engaging part 22 which is disposed in an end of each rib 21 and is fixedly assembled to the casing 30.

2. In a speaker structure that a magnet and a voice coil are installed in the interior of a housing disposed in an inner side of an external casing of a bone conduction speaker and are engaged with a yoke, and a diaphragm is installed in an outer side of the yoke, a bone conduction speaker having a vibration prevention structure, comprising:
one or at least two ribs 21 which are formed in an outer side of the housing 10; and
an engaging part 22 which is disposed in an end of each rib 21 and is fixedly assembled to the casing 30.

3. The speaker of claim 1, wherein an engaging part 22, which has an engaging hole 23 for an engagement to the casing 30 by means of an engaging means such as a screw or a rivet, is formed in an end of each rib 21, and a narrow neck 24 is formed between the engaging part 22, the diaphragm 20 and an outer side of the housing 10.

4. The speaker of claim 1, wherein said rib 21 is formed of a wrinkle part 25 in a vertical or horizontal direction.

5. The speaker of claim 1, wherein said rib 40 is bent in a Z-shape.

6. The speaker of claim 1, wherein when assembling the engaging part 22 of the rib 21 to the casing, an anti-vibration member 50 is assembled to the upper and lower surfaces of the rib 21 for thereby enhancing an impact and vibration prevention effect.

7. In a speaker structure that a magnet and a voice coil are installed in the interior of a housing disposed in an inner side of an external casing of a bone conduction speaker and are engaged with a yoke, and a diaphragm is installed in an outer side of the yoke, a bone conduction speaker having a vibration prevention structure, comprising:
one or at least two ribs 21 which are formed as an outer side of the diaphragm 20 is outwardly extended;
an engaging part 22 which is disposed in an end of each rib 21 and is fixedly assembled to the casing 30; and
an elastic member 60 which is disposed closer to a backside of the housing 10 for thereby providing an elastic force with respect to a vertical vibration direction of the housing 10.

8. In a speaker structure that a magnet and a voice coil are installed in the interior of a housing disposed in an inner side of an external casing of a bone conduction speaker and are engaged with a yoke, and a diaphragm is installed in an outer side of the yoke, a bone conduction speaker having a vibration prevention structure, comprising:
one or at least two ribs 21 which are formed in an outer side of the housing 10;
an engaging part 22 which is disposed in an end of each rib 21 and is fixedly assembled to the casing 30; and
an elastic member 60 which is disposed closer to a backside of the housing 10 for thereby providing an elastic force with respect to a vertical vibration direction of the housing 10.

9. The speaker of claim 7, wherein said elastic member 60 is formed of a sponge.

10. The speaker of claim 7, wherein said elastic member 60 is formed of a spring 61.

11. The speaker of claim 7, wherein said spring 61 is formed in a double structure that it is installed closer to a backside of the housing 10 and it is directly connected with an outer surface of the housing 10.

12. The speaker of claim 7, wherein said spring 61 is directly installed in contact with a backside of the housing 10, and a power supplied to the housing 10 is electrically connected by means of the assistant spring 64.

13. The speaker of claim 2, wherein an engaging part 22, which has an engaging hole 23 for an engagement to the casing 30 by means of an engaging means such as a screw or a rivet, is formed in an end of each rib 21, and a narrow neck 24 is formed between the engaging part 22, the diaphragm 20 and an outer side of the housing 10.

14. The speaker of claim 2, wherein said rib 21 is formed of a wrinkle part 25 in a vertical or horizontal direction.

15. The speaker of claim 2, wherein said rib 40 is bent in a Z-shape.

16. The speaker of claim 2, wherein when assembling the engaging part 22 of the rib 21 to the casing, an anti-vibration member 50 is assembled to the upper and lower surfaces of the rib 21 for thereby enhancing an impact and vibration prevention effect.

17. The speaker of claim 8, wherein said elastic member 60 is formed of a sponge.

18. The speaker of claim 8, wherein said elastic member 60 is formed of a spring 61.

19. The speaker of claim 8, wherein said spring 61 is formed in a double structure that it is installed closer to a backside of the housing 10 and it is directly connected with an outer surface of the housing 10.

20. The speaker of claim 8, wherein said spring 61 is directly installed in contact with a backside of the housing 10, and a power supplied to the housing 10 is electrically connected by means of the assistant spring 64.
